(19) United States
(12) Patent Application Publication
(10) Pub. No.: US 2007/0224408 A1
(43) Pub. Date: Sep. 27, 2007

(54) Resin molded article and production method thereof

(75) Inventors: Koichi Kimura, Kawasaki (JP); Masanobu Ishiduka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/727,387

(22) Filed: Mar. 26, 2007

(30) Foreign Application Priority Data
Mar. 27, 2006 (JP) 2006-086118

(51) Int. Cl. B32B 15/08; B31B 1/60; B32B 17/02; B32B 27/12; B32B 15/14; B32B 27/38; B32B 17/06; B32B 27/04

(52) U.S. Cl. 428/301.1; 442/376; 442/172; 442/288; 428/432; 428/418; 156/60

(57) ABSTRACT

An adhesive as a heat resistant rubber-based adhesive is applied to a region (peripheral region) of integration of a metal sheet (Al sheet) and a resin and to a region (peripheral region) of integration of a fiber sheet (CF sheet) and a resin. The metal sheet and fiber sheet are temporarily fixed to dry the adhesive, then, the joined article is accommodated in an injection molding machine, a polycarbonate resin is injected, and the joined article (metal sheet and fiber sheet) is integrally molded with the polycarbonate resin.

### CROSS-REFERENCE TO RELATED APPLICATIONS

This Nonprovisional application claims priority under 35 U.S.C. §119(a) on Patent Application No. 2006-86118 filed in Japan on Mar. 27, 2006, the entire contents of which are hereby incorporated by reference.

### BACKGROUND OF THE INVENTION

The present invention relates to a resin molded article molded of a resin and its production method, and particularly, to a resin molded article excellent in both portability and fanciness and its production method.

Differentiation of electronic devices such as personal computers, digital cameras, digital video cameras, portable telephones and the like are becoming difficult owing to common use of CPU and inner constitution parts. For establishing differentiation of these electronic devices from the standpoint of the exterior appearance, portability of a housing such as lightness and strength and fanciness of a housing such as color tone, gloss and the like are necessary.

For realizing excellent portability of such electronic device housings accommodating therein electronic devices, there are known a housing made using a light Mg alloy, a housing made using a high rigidity plastic obtained by adding carbon fiber (CF) or glass fiber (GF) to a polycarbonate (PC) resin or a polyamide (PA) resin, a housing made using a material obtained by impregnating carbon fiber into a thermosetting plastic, and the like (Japanese Patent Application Laid-Open No. 2005-165930). On the other hand, for providing an electronic device housing excellent in fanciness, metallic multilayer painting containing an aluminum powder added, gloss painting of piano tone by ultraviolet clear painting, and the like are applied.

### BRIEF SUMMARY OF THE INVENTION

However, the housing made using a Mg alloy has problems that molding is difficult and mass productivity is low, and a flattening treatment of the surface after molding is necessary. The housing made using a high rigidity plastic has a problem that the thickness of painting should be about 30 μm or more for generating metal feeling. The housing obtained by impregnating carbon fiber into a thermosetting plastic has a problem that complicated shapes of a boss part, rib part and the like cannot be molded. On the other hand, the application methods as described above have problems that cost is high, painting is performed for several layers, thus, dust and trash mix in the painting, and the like. Thus, the housings intending improvement in portability and fanciness have respective some problems, that is, realization of excellent portability and fanciness is difficult.

The present invention has been achieved in view of such conditions, and has an object of providing a resin molded article which can realize excellent portability and excellent fanciness simply and simultaneously.

Another object of the present invention is to provide a method for producing a resin molded article which can produce a resin molded article having excellent portability and excellent fanciness simultaneously, in a simple manner and at low cost.

The resin molded article according to the present invention is a resin molded article molded of a resin, the article having a metal sheet, a fiber sheet and a resin for integral molding of the metal sheet and the fiber sheet.

In the resin molded article of the present invention, a metal sheet and a fiber sheet are integrally molded with a resin. Since a metal sheet contributing to exterior appearance has a smooth surface, colorful painting treatment is possible, and metal feeling and gloss are obtained easily. Further, since a fiber sheet is used, weight saving is attained as compared with a single metal sheet, and a fiber sheet and a resin are combined, thus, high rigidity is obtained as compared with combination of a metal sheet and a resin. Resultantly, both portability and fanciness are excellent. In the present invention, since a metal sheet and a fiber sheet are integrally molded with a resin, a resin molded article realizing excellent portability and excellent fanciness simultaneously can be provided with simple constitution.

The resin molded article according to the present invention has a boss part and/or a rib part made of resin. The resin molded article of the present invention has a boss part and/or a rib part which can be manufactured easily by resin molding.

In the resin molded article according to the present invention, the fiber sheet is a sheet made singly of fiber or a sheet obtained by impregnating fiber with resin. The fiber sheet contains fiber in the form of nonwoven fabric or woven fabric. In the resin molded article according to the present invention, used as the fiber sheet is a sheet made singly of fiber or a sheet obtained by impregnating fiber with resin. That is, the weight of a housing does not increase. When the fiber sheet is made of woven fabric, anisotropy along longitudinal and lateral directions disappears and deformation of the resin molded article does not occur easily.

The method for producing a resin molded article according to the present invention includes the steps of applying an adhesive on a metal sheet and a fiber sheet, and injecting a resin on a region of application of the adhesive to perform integral molding of the metal sheet and the fiber sheet with the resin, in a method for producing a resin molded article molded of a resin.

In the method for producing a resin molded article according to the present invention, an adhesive is applied to a metal sheet and a fiber sheet, then, a resin is injected to a region of application of the adhesive, and the metal sheet and the fiber sheet are integrally molded with the resin to produce a resin molded article. By injection of a resin, complicated shape parts such as a boss part, rib part, side wall part and the like can be fabricated easily. Since resin injection molding is used for integration, the production process is simple requiring no high cost. In the present invention, a resin is injected to a region of application of an adhesive on a metal sheet and a fiber sheet, therefore, a resin molded article having excellent portability and excellent fanciness simultaneously can be produced simply at low cost, and additionally, a boss part a rib part constituting complicated shape can be fabricated simply.

In the method for producing a resin molded article according to the present invention, the adhesive is a heat resistance rubber-based adhesive. In the method for producing a resin molded article of the present invention, a thermoplastic adhesive is used as the adhesive. Particularly, a nitrile rubber-based adhesive and a chloroprene rubber-based adhesive as the heat resistance rubber-based adhesive have an action of relaxing thermal expansion of a sheet material. Thus, the produced resin molded article can be subjected to heat treatment to disaggregate the fiber sheet, metal sheet and resin. In the present invention, a heat resistant rubber-based adhesive is used as the adhesive in integral molding, therefore, the metal sheet, fiber sheet and resin can be separated by heating, and these components can be disaggregated in recycling.

The above and further objects and features of the invention will more fully be apparent from the following detailed description with accompanying drawings.

### BRIEF DESCRIPTION OF THE SEVERAL VIEWS OF THE DRAWINGS

FIG. 1A is a plane view showing the constitution of one example of an electronic device housing;

FIG. 1B is a side view showing the constitution of one example of an electronic device housing;

FIG. 2 is a plane view showing constitution members of an electronic device housing; and

FIGS. 3A-3C are views showing a process for producing an electronic device housing.

### DETAILED DESCRIPTION OF THE INVENTION

Embodiments will be specifically illustrated referring to drawings. In the following embodiments, examples of an electronic device housing as the resin molded article are explained, but the present invention is not limited to the following embodiments.

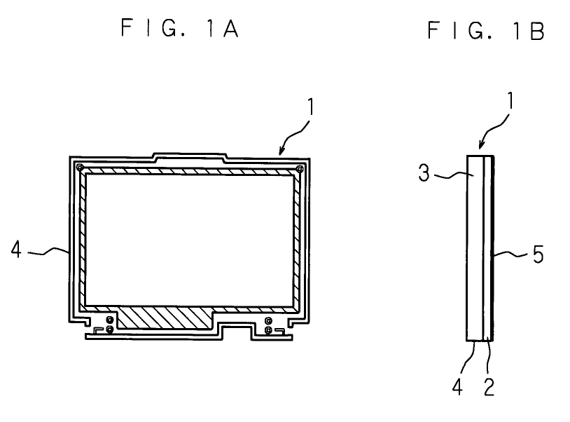

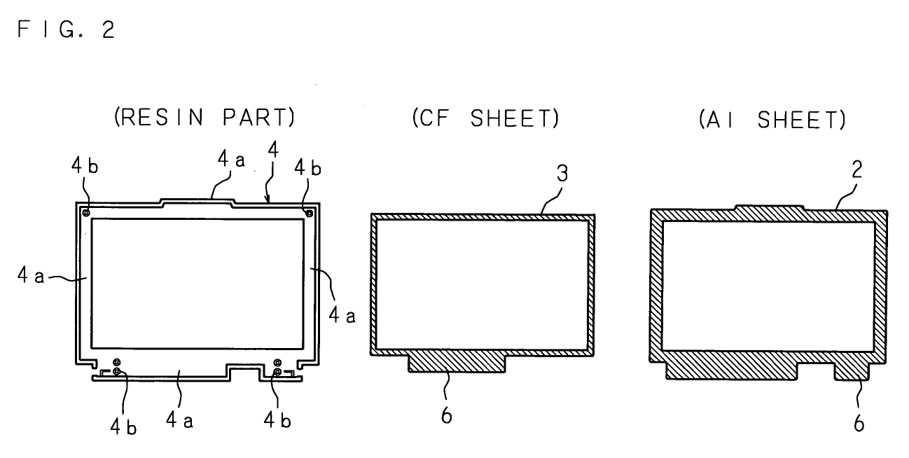

FIG. 1 is a view showing the constitution of one example of an electronic device housing, and FIG. 1A is its plan view, and FIG. 1B is its side view. FIG. 2 is a plan view showing constitution members of an electronic device housing. This electronic device housing 1 is constituted of a metal sheet 2 on back surface side and a fiber sheet 3 on front surface side carrying thereon an applied adhesive, the sheets 2, 3 being integrally molded with a resin, and its thickness is 0.5 to 2.0 mm. The electronic device housing 1 is divided into the metal sheet 2, fiber sheet 3 and resin part 4 as shown in FIG. 2.

The metal sheet 2 is specifically an Al sheet having a thickness of 0.1 to 1.0 mm, and on the back surface (surface on the side of no contact with the fiber sheet 3) of the metal sheet 2, coating of a Ti layer 5 is applied. The fiber sheet 3 is specifically a CF sheet having a thickness of 0.1 to 1.0 mm obtained by interweaving carbon fiber. The resin part 4 is made of a polycarbonate resin, and has a side wall part 4a and a boss part 4b.

In the electronic device housing 1 obtained by integral molding with a resin of the metal sheet 2 and the fiber sheet 3 carrying thereon an applied adhesive 6 (hatched portion), the metal sheet 2 is situated on its back surface side and the back surface of the metal sheet 2 is smooth, thus, various painting treatments are possible on its back surface. Therefore, the electronic device housing 1 can manifest metal feeling, gloss feeling and the like easily, and improvement in fanciness can be realized easily. The metal sheet 2 has high thermal conductivity, and contributes to realization of excellent heat dischargeability.

On the other hand, when a metal sheet is singly used, the weight of a housing becomes heavy for obtaining sufficient rigidity to generate a problem in portability, thus, for reducing the weight of a housing, the metal sheet 2 and the fiber sheet 3 are used together, intending reduction in the weight of a housing. Since the metal sheet 2 and the fiber sheet 3 are combined with a resin, high rigidity can be obtained as compared with a case of combination of only a metal sheet with a resin. Therefore, the electronic device housing 1 can easily realize improvement in portability such as lightness and strength.

Thus, the metal sheet 2 contributes to improvement in fanciness and the fiber sheet 3 contributes to improvement in portability, that is, the electronic device housing 1 excellent in both portability and fanciness can be provided. The above-mentioned housing may also be obtained by combination of a sheet and a resin in the case of emphasis of texture of cloth.

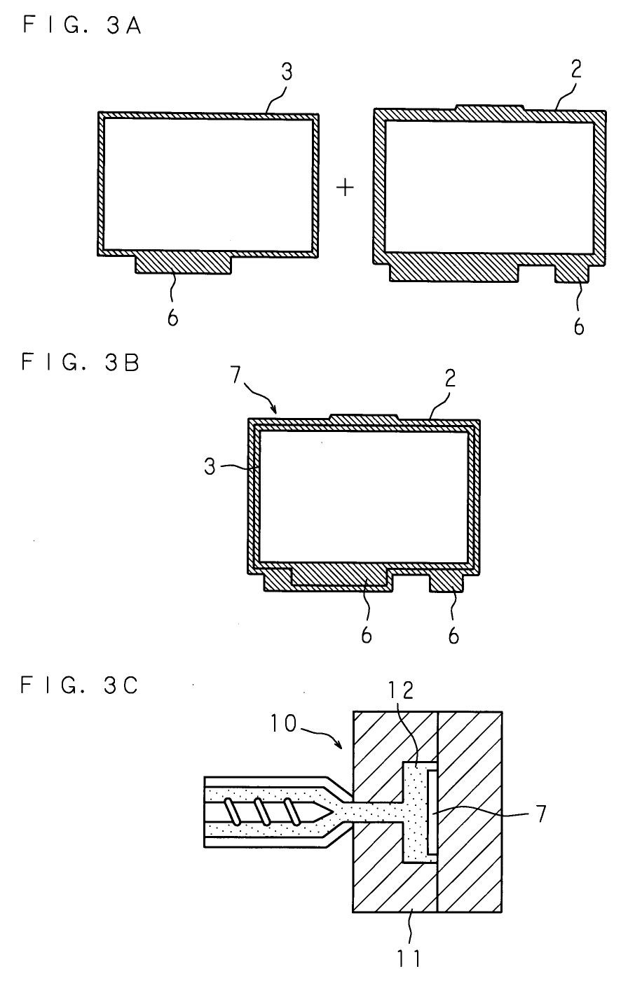

Next, the method for producing the electronic device housing 1 will be illustrated. FIGS. 3A-3C are views showing its process. An adhesive 6 is applied to a region (peripheral region) of integration of the metal sheet 2 (Al sheet) and a resin and to a region (peripheral region) of integration of the fiber sheet 3 (CF sheet) and a resin (FIG. 3A). As the adhesive 6, heat resistant rubber-based adhesives such as a nitrile rubber-based adhesive, chloroprene rubber-based adhesive and the like are used.

These metal sheet 2 and fiber sheet 3 are temporarily fixed by the same adhesive 6 so that the metal sheet 2 situates on the back surface side and the fiber sheet 3 situates on the front surface side (FIG. 3B). For suppressing stickiness of the adhesive 6 to improve workability, the adhesive 6 is dried. Since a heat resistant rubber-based adhesive is used, even if it is dried, it is melted in heating to give adhesion.

A joined article 7 of the metal sheet 2 and the fiber sheet 3 temporarily fixed is accommodated in an injection molding machine 10 having a mold 11 corresponding to the shape of the resin part 4, and a polycarbonate resin 12 is injected, and its joined article 7 (metal sheet 2 and fiber sheet 3) is integrally molded with the polycarbonate resin (FIG. 3C). In this condition, the joined article 7 is situated so that the fiber sheet 3 faces the injection molding machine 10. This molded article is removed from the injection molding machine 10 and placed on a rotary table in a vacuum chamber, and the Ti layer 5 is coated on the back surface of the metal sheet 2 by vapor deposition according to a CVD method.

Since the resin part 4 is molded by injecting a resin to a joined article of a sheet, a boss part 4b constituting complicated shape can also be manufactured simply. As a result, mass production at low cost can be realized.

Since the heat resistant rubber-based adhesive is used in integral molding, the electronic device housing can be separated into the metal sheet 2, fiber sheet 3 and resin part 4 in heating, and can be easily disaggregated in recycling.

Though the material of the metal sheet 2 is singly composed of Al in the above example, additionally, respective single bodies of Mg, Ti, SUS and Zn and an alloy containing these metals including also Al may also be used.

Though the material of the fiber sheet 3 is singly composed of carbon fiber in the above example, additionally, natural fiber single bodies such as glass fiber (GF) single body, kenaf, hemp and the like and nonwoven fabric and interwoven sheets obtained by combining these fibers including also carbon fiber with an epoxy resin and the like may also be used. By impregnation of a resin, the hardness of the sheet increases.

Though the material of the resin part 4 is composed of a polycarbonate resin in the above example, thermoplastic resins such as ABS resins, PC-ABS resins, PA resins, PLA resins and the like and other thermosetting resins such as epoxy resins, phenol resins, polyester resins and the like may also be used. Further, to these resins, natural fiber single bodies such as glass fiber (GF) single body, kenaf, hemp and the like, or these fibers including also carbon fiber, and fillers in the form of flake, sphere and plate may also be added.

Further, though coating of the Ti layer 5 is applied on the back surface of the metal sheet 2 in the above example, surface treatments such as organic painting, alumite, plating and the like may also be performed.

Furthermore, though a housing having the boss part 4b is explained in the above example, it is needless to say regarding a housing having a rib part that its rib part can be manufactured easily by injection molding of a resin.

Though an electronic device housing is explained as an example in the above example, it is needless to say that the present invention can be applied to housings other than the electronic device housing, and general resin molded articles molded of a resin such as frames, boxes, members and the like.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

What is claimed is:

1. A resin molded article molded of a resin, comprising:
a metal sheet;
a fiber sheet; and
a resin used for integral molding of said metal sheet and said fiber sheet.

2. The resin molded article according to claim 1, comprising a boss part and/or a rib part made of said resin.

3. The resin molded article according to claim 1, wherein said fiber sheet is a sheet made singly of fiber, or a sheet obtained by impregnating fiber with a resin.

4. The resin molded article according to claim 3, wherein said fiber sheet contains fiber in the form of nonwoven fabric or woven fabric.

5. The resin molded article according to claim 3, wherein said fiber sheet contains fiber selected from the group consisting of carbon fiber, glass fiber, kenaf and hemp.

6. The resin molded article according to claim 1, wherein said metal sheet is made singly of Al, Mg, Ti, SUS or Zn, or made of an alloy containing these metals.

7. The resin molded article according to claim 1, wherein at least any of metal coating, organic painting and surface treatment is applied on the back surface of said metal sheet.

8. A method for producing a resin molded article molded of a resin, comprising the steps of
applying an adhesive on a metal sheet and a fiber sheet; and
injecting a resin on a region of application of said adhesive, to perform integral molding of said metal sheet and said fiber sheet with said resin.

9. The method for producing a resin molded article according to claim 8, wherein said adhesive is a heat resistant rubber-based adhesive.

10. The method for producing a resin molded article according to claim 9, wherein said heat resistant rubber-based adhesive is a nitrile rubber-based adhesive or chloroprene rubber-based adhesive.
